(19) United States
(12) Patent Application Publication
(10) Pub. No.: US 2022/0335292 A1
(43) Pub. Date: Oct. 20, 2022

(54) INFORMATION PROCESSING DEVICE, INFORMATION PROCESSING METHOD, AND PROGRAM

(71) Applicant: Sony Group Corporation, Tokyo (JP)

(72) Inventors: Suguru AOKI, Tokyo (JP); Ryuta SATOH, Tokyo (JP); Tetsu OGAWA, Tokyo (JP); Itaru SHIMIZU, Tokyo (JP)

(73) Assignee: Sony Group Corporation, Tokyo (JP)

(21) Appl. No.: 17/641,011

(22) PCT Filed: Oct. 1, 2020
(86) PCT No.: PCT/JP2020/037433

§ 371 Date: Mar. 7, 2022

(30) Foreign Application Priority Data
Oct. 11, 2019 (JP) 2019-187424

(51) Int. Cl. G06N 3/08; G06K 9/62

(52) U.S. Cl. CPC G06N 3/08; G06K 9/6263

(57) ABSTRACT

The present technology relates to an information processing device, an information processing method, and a program that make it possible to do re-learning when an environment change occurs.

A determination unit that determines an action in response to input information on the basis of a predetermined learning model; and a learning unit that performs a re-learning of the learning model when a change in a reward amount for the action is a change exceeding a predetermined standard are included. The learning model is a learning model generated or updated through reinforcement learning. The present technology can be applied to an information processing device that carries out, for example, predetermined reinforcement learning.

### TECHNICAL FIELD

The present technology relates to an information processing device, an information processing method, and a program, and more specifically, an information processing device, an information processing method, and a program that achieve learning suitable for a new environment when, for example, the learning environment has changed.

### BACKGROUND ART

The machine learning in which a control method for attaining the goal of maximizing a value (profit) in an environment is learned through trial and error is called reinforcement learning in a broad sense. Patent Document 1 discloses a technology for shortening the time required for reinforcement learning.

### CITATION LIST

### Patent Document

Patent Document 1: Japanese Patent Application Laid-Open No. 2006-313512

### SUMMARY OF THE INVENTION

### Problems to be Solved by the Invention

However, conventionally, once learning is done, re-learning may take time to adapt to a new environment when the learned environment has changed to a different environment.

The present technology has been made in view of such circumstances, and is intended to detect a change in the environment and cope with a new environment as quickly as possible when the environment has changed.

### Solutions to Problems

An information processing device according to one aspect of the present technology includes: a determination unit that determines an action in response to input information on the basis of a predetermined learning model; and a learning unit that performs a re-learning of the learning model when a change in a reward amount for the action is a change exceeding a predetermined standard.

An information processing method according to one aspect of the present technology includes: by an information processing device, determining an action in response to input information on the basis of a predetermined learning model; and performing a re-learning of the learning model when a change in a reward amount for the action is a change exceeding a predetermined standard.

A program according to one aspect of the present technology causes a computer to execute a process including the steps of: determining an action in response to input information on the basis of a predetermined learning model; and performing a re-learning of the learning model when a change in a reward amount for the action is a change exceeding a predetermined standard.

In an information processing device, an information processing method, and a program according to one aspect of the present technology, an action in response to input information is determined on the basis of a predetermined learning model, and a re-learning of the learning model is performed when a change in a reward amount for the action is a change exceeding a predetermined standard.

Note that the information processing device may be an independent device, or may be an internal block that forms one device.

Furthermore, the program can be provided by being transmitted via a transmission medium or by being recorded on a recording medium.

### BRIEF DESCRIPTION OF DRAWINGS

FIG. 1 is a diagram illustrating a configuration of an information processing device to which the present technology is applied according to an embodiment.

FIG. 2 is a diagram illustrating a functional configuration example of the information processing device.

FIG. 3 is a diagram for explaining an example of reinforcement learning.

FIG. 4 is a flowchart for explaining a learning process.

FIG. 5 is a flowchart for explaining another learning process.

FIG. 6 is a diagram for explaining a case where a plurality of learning models is stored.

FIG. 7 is a flowchart for explaining a first application example.

FIG. 8 is a flowchart for explaining a second application example.

FIG. 9 is a flowchart for explaining a third application example.

FIG. 10 is a flowchart for explaining a fourth application example.

FIG. 11 is a flowchart for explaining a fifth application example.

FIG. 12 is a flowchart for explaining a sixth application example.

FIG. 13 is a flowchart for explaining a seventh application example.

FIG. 14 is a flowchart for explaining an eighth application example.

FIG. 15 is a flowchart for explaining a ninth application example.

FIG. 16 is a flowchart for explaining a tenth application example.

### MODE FOR CARRYING OUT THE INVENTION

A mode for carrying out the present technology (hereinafter referred to as an embodiment) will now be described.

The present technology can be applied to an information processing device that carries out reinforcement learning. As reinforcement learning, the present technology can be applied to a learning method employing long short-term memory (LSTM). Although description is given here about an example in which the present technology is applied to LSTM, the present technology can also be applied to reinforcement learning based on another method.

<Configuration of Information Processing Device>

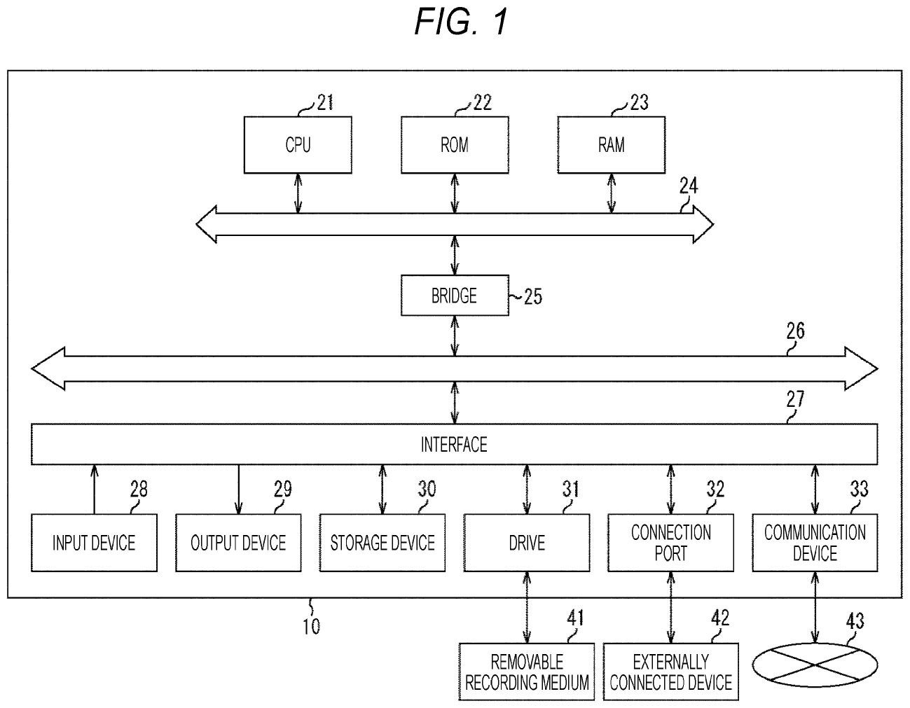

FIG. 1 is a diagram illustrating a configuration of an information processing device to which the present technology is applied according to an embodiment. An information processing device 10 may include, for example, a personal computer.

The information processing device 10 includes a CPU 21, a ROM 22, and a RAM 23 as major components. Furthermore, the information processing device 10 includes a host bus 24, a bridge 25, an external bus 26, an interface 27, an input device 28, an output device 29, a storage device 30, a drive 31, a connection port 32, and a communication device 33.

The CPU 21 functions as an arithmetic processing device and a control device, and controls operations in the information processing device 10 in whole or in part in accordance with various programs recorded in the ROM 22, the RAM 23, the storage device 30, or the removable recording medium 41. The ROM 22 stores programs, operation parameters, and the like to be used by the CPU 21. The RAM 23 primarily stores programs to be used by the CPU 21, parameters that vary as appropriate during execution of a program, and the like. These are connected to one another by the host bus 24 including an internal bus such as a CPU bus.

The host bus 24 is connected to the external bus 26 such as a peripheral component interconnect (PCI) bus via the bridge 25. Furthermore, to the external bus 26, the input device 28, the output device 29, the storage device 30, the drive 31, the connection port 32, and the communication device 33 are connected via the interface 27.

The input device 28 is operation means operated by the user, such as a mouse, a keyboard, a touch panel, a button, a switch, a lever, a pedal, and the like, for example. Furthermore, the input device 28 may be, for example, remote control means (a so-called remote controller) employing infrared rays or other radio waves, or may be an externally connected device supporting operation of the information processing device 10, such as a mobile phone, a PDA, and the like. Moreover, the input device 28 includes, for example, an input control circuit that generates an input signal on the basis of information input by the user by using the above-described operation means and outputs the generated input signal to the CPU 21. By operating the input device 28, the user of the information processing device 10 can input various types of data to the information processing device 10 and instruct the information processing device 10 to do processing operations.

In addition, the input device 28 may be various types of sensors. For example, the input device 28 may be sensors such as an image sensor, a gyro sensor, an acceleration sensor, a temperature sensor, an atmospheric pressure sensor, and the like, or may be a device functioning as an input unit that accepts outputs from these sensors.

The output device 29 includes a device that can visually or audibly give notification of the acquired information to the user. Examples of such a device include a display device such as a CRT display device, a liquid crystal display device, a plasma display device, an EL display device, and a lamp, an audio output device such as a speaker and a headphone, a printer device, and the like. The output device 29 outputs, for example, results obtained by the information processing device 10 performing various types of processing. Specifically, the display device displays the results obtained by the information processing device 10 performing various types of processing in the form of text or images. On the other hand, the audio output device converts an audio signal including the reproduced audio data, acoustic data, and the like into an analog signal, and outputs the analog signal.

Alternatively, in a case where the information processing device 10 functions as a part of a control unit that controls a vehicle or a robot, the output device 29 may be a device that outputs information for movement control to individual units, or may be a motor, a brake, or the like that performs movement control.

The storage device 30 is a data storage device configured as an example of the storage unit in the information processing device 10. The storage device 30 includes, for example, a magnetic storage unit device such as a hard disk drive (HDD), a semiconductor storage device, an optical storage device, a magneto-optical storage device, or the like. The storage device 30 stores programs to be executed by the CPU 21, various types of data, and the like.

The drive 31 is a reader/writer for a recording medium, and is built in or externally attached to the information processing device 10. The drive 31 reads information recorded on the attached removable recording medium 41, such as a magnetic disk, an optical disk, a magneto-optical disk, or a semiconductor memory, and outputs the information to the RAM 23. Furthermore, the drive 31 is capable of writing a record onto the attached removable recording medium 41, such as a magnetic disk, an optical disk, a magneto-optical disk, or a semiconductor memory. The removable recording medium 41 is, for example, a DVD medium, an HD-DVD medium, or a Blu-ray (registered trademark) medium. Furthermore, the removable recording medium 41 may be CompactFlash (registered trademark) (CF), a flash memory, a Secure Digital memory card (SD memory card), or the like. Furthermore, the removable recording medium 41 may be, for example, an integrated circuit card (IC card) on which a non-contact IC chip is mounted or an electronic device.

The connection port 32 is a port for direct connection to the information processing device 10. Examples of the connection port 32 include a universal serial bus (USB) port, an IEEE 1394 port, a small computer system interface (SCSI) port, and the like. Other examples of the connection port 32 include an RS-232C port, an optical audio terminal, a high-definition multimedia interface (HDMI (registered trademark)) port, and the like. By connecting an externally connected device 42 to the connection port 32, the information processing device 10 directly acquires various types of data from the externally connected device 42 and supplies various types of data to the externally connected device 42.

The communication device 33 is, for example, a communication interface including a communication device or the like for connecting to a communication network 917. The communication device 33 is, for example, a communication card or the like for a wired or wireless local area network (LAN), Bluetooth (registered trademark), or wireless USB (WUSB). Alternatively, the communication device 33 may be a router for optical communication, a router for asymmetric digital subscriber line (ADSL), a modem for various types of communication, or the like. The communication device 33 is capable of transmitting and receiving signals and the like to and from, for example, the Internet or another communication device in accordance with a predetermined protocol such as TCP/IP. Furthermore, the communication network 43 connected to the communication device 33 may include a network or the like connected in a wired or wireless manner, and may be, for example, the Internet, a home LAN, infrared communication, radio wave communication, satellite communication, or the like.

<Functions of Information Processing Device>

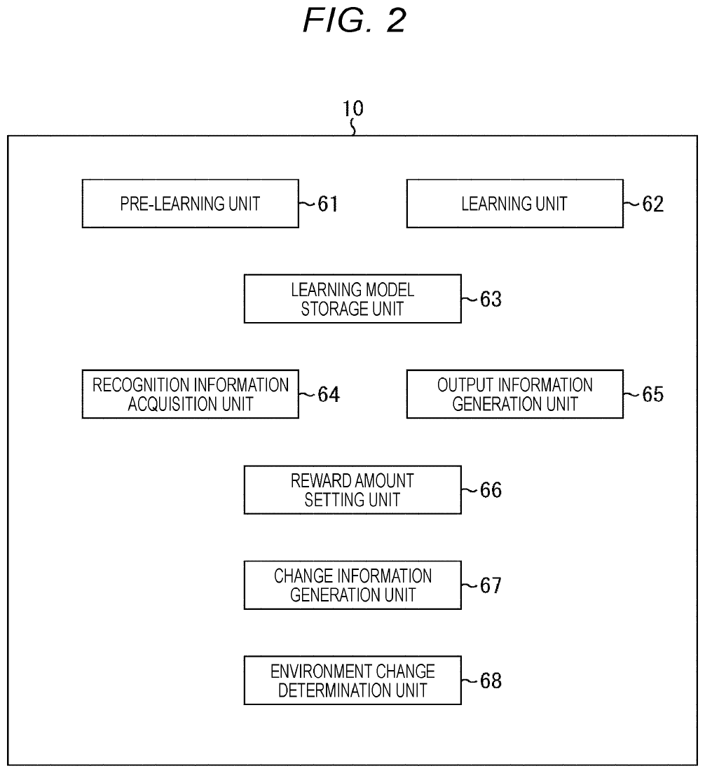

FIG. 2 is a block diagram illustrating functions of the information processing device 10. The information processing device 10 includes a pre-learning unit 61, a learning unit 62, a learning model storage unit 63, a recognition information acquisition unit 64, an output information generation unit 65, a reward amount setting unit 66, a change information generation unit 67, and an environment change determination unit 68.

The pre-learning unit 61 and the learning unit 62 do learning by a predetermined learning method to generate or update a learning model. Although description is given here, as an example, about a case where two learning units, namely the pre-learning unit 61 and the learning unit 62, are included, a single learning unit may only be included. Description is further given here on the assumption that the learning before the user starts using the information processing device 10 (learning within a predetermined time period after the device becomes in use) is done by the pre-learning unit 61, and the learning after the user starts using the information processing device 10 is done by the learning unit 62.

In the phase of manufacturing the information processing device 10, for example, in the factory shipment phase (prior to use by the user), the pre-learning unit 61 does learning in a pseudo environment simulating an environment where the information processing device 10 is in use to generate a learning model (hereinafter referred to as an initial learning model as appropriate). The generated initial learning model is stored in the learning model storage unit 63.

The learning unit 62 updates or newly generates a learning model by doing re-learning when an environment change, which is described later, is detected. The learning model storage unit 63 stores an initial learning model, an updated learning model, and a newly generated learning model.

The recognition information acquisition unit 64 acquires recognition information. The recognition information, which is input information to be input to the information processing device 10, is used for generating information to be presented by the information processing device 10 (information to be output). The recognition information includes information regarding the user and information regarding the environment in which the system is involved, such as a history of user actions, weather information, and traffic jam information.

The output information generation unit 65 determines an action on the basis of the recognition information and the learning model. For example, in the case of a system for generating conversations, when information regarding the weather is acquired as recognition information, utterance information intended for an action of providing a topic about the weather to the user is generated.

The reward amount setting unit 66 sets a reward amount. The reward amount can be, for example, information obtained from the user's reaction to the information presented by the information processing device 10.

The information processing device 10 performs processing based on reinforcement learning. Reinforcement learning is the learning intended to maximize a value (profit) in a given environment, and can be defined as the learning in which an environment change to occur as a result of an action of an agent (action subject) is evaluated, a reward is derived from the change on the basis of a predetermined evaluation function, and feedback for maximizing the reward amount is given to the learning model.

The reward amount set by the reward amount setting unit 66 represents how much reward (which may be referred to as an evaluation function) is obtained as a result of an action taken by an agent (which is the information processing device 10 in the present embodiment) in a certain state. In addition, the state represents the current specific state of the environment. In addition, the action represents a specific action that can be taken by the agent to the environment.

Note that the reinforcement learning to which the present technology can be applied includes the case where the learning model includes a network of plurality of intermediate layers.

In the information processing device shown in FIG. 2, the output information generation unit 65 generates output information for which a reward for the recognition information acquired by the recognition information acquisition unit 64 is to be obtained. For example, in a system in which the user's reaction is used as a reward amount, when the generated output information is presented to the user and a favorable reaction is given by the user, a reward is obtained.

Thus, in a case where the user's reaction is used as a reward, when the user's reaction is not a favorable reaction, a change like a decrease in the reward amount occurs. On the basis of such change in the reward amount, the change information generation unit 67 generates change information. The change information generation unit 67 generates a flag indicating whether or not a significant change in the reward amount has occurred. For example, when it is determined that a significant change in the reward amount has occurred, information “1” is generated as the change information, and when it is determined that an insignificant change (no change) in the reward amount has occurred, information “0” is generated as the change information.

Although description is further given here on the assumption that “1” is generated when the reward amount is significant and “0” is generated when the reward amount is insignificant, “0” may be generated when the reward amount is significant and “1” may be generated when the reward amount is insignificant. In addition, although description is further given here on the assumption that the change information is a flag of 0 or 1, the change information may be other information. For example, the change information may be a value corresponding to the significance of the reward amount. For example, a value in a range of 0 to 10 may be assigned depending on the significance of the reward amount.

The environment change determination unit 68 determines whether or not the environment has changed. When the change information is “0” (when the change in the reward amount is insignificant), the environment change determination unit 68 determines that the environment has not changed, and when the change information is “1” (when the change in the reward amount is significant), the environment change determination unit 68 determines that the environment has changed. When it is determined that the environment has changed, the environment change determination unit 68 gives an instruction to the learning unit 62 to start re-learning.

As described above, the information processing device 10 to which the present technology is applied detects that the environment has changed and, when an environment change is detected, the information processing device 10 performs re-learning.

<Case of Applying LSTM>

A learning method employing LSTM can be applied to the learning done by the information processing device 10. LSTM is a model for time series data with an extended recurrent neural network (RNN). A characteristic of LSTM is being capable of learning long-term dependencies.

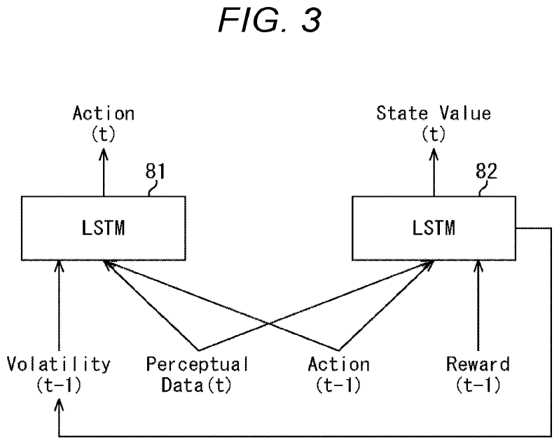

FIG. 3 shows an example structure of LSTM. An LSTM 81 mainly performs learning while an LSTM 82 mainly detects an environment change. To the LSTM 81, change information at previous time t−1 (Volatility (t−1)), recognition information at present time t (Perceptual Data (t)), and an output at previous time t−1 (Action (t−1)) are input.

To the LSTM 82, recognition information at present time t (Perceptual Data (t)), an output at previous time t−1 (Action (t−1), and a reward at previous time t−1 (Reward (t−1)) are input.

The LSTM 82 makes an evaluation (State Value (t)) of the previous output (Action (t−1)) on the basis of the recognition information (Perceptual Data (t)) and the reward (Reward (t−1). In addition, the LSTM 82 determines whether or not the reward amount has significantly changed. If it is determined that the reward amount has not significantly changed, the LSTM 82 outputs the change information “0” (Volatility (t−1)) to the LSTM 81, and if it is determined that the reward amount has significantly changed, the LSTM 82 outputs the change information “1” (Volatility (t−1)) to the LSTM 81.

The LSTM 81 determines the output (Action (t)) at the present time (time t) on the basis of the recognition information (Perceptual Data (t)). When the output (Action (t)) is being determined, a learning model already learned on the basis of a reward under a certain condition may be referred to, or any learning model other than such learning model may be referred to.

In addition, when the change information (Volatility (t−1)) is “0” and it is determined that no environment change has occurred, the LSTM 81 determines the output (Action (t)) on the basis of the learning model that is currently referred to. On the other hand, when the change information (Volatility (t−1)) is “1” and it is determined that an environment change has occurred, the LSTM 81 changes the output (Action (t)) on the basis of the recognition information (Perceptual Data (t)) and of the output at previous time (time t−1) (Action (t−1)). That is, when it is determined that an environment change has occurred, re-learning is done on the basis of a condition after the environment change by using the change information (Volatility) as a reward.

In this way, the LSTM 82 detects an environment change from a change in the reward amount, and when any environment change is detected, the LSTM 81 starts re-learning. Note that, although description has been given here about an example of reinforcement learning for detecting an environment change and starting re-learning by taking LSTM as an example, the information processing device 10 can be configured to detect an environment change and start re-learning by applying another type of reinforcement learning.

<About Processing Performed by Information Processing Device>

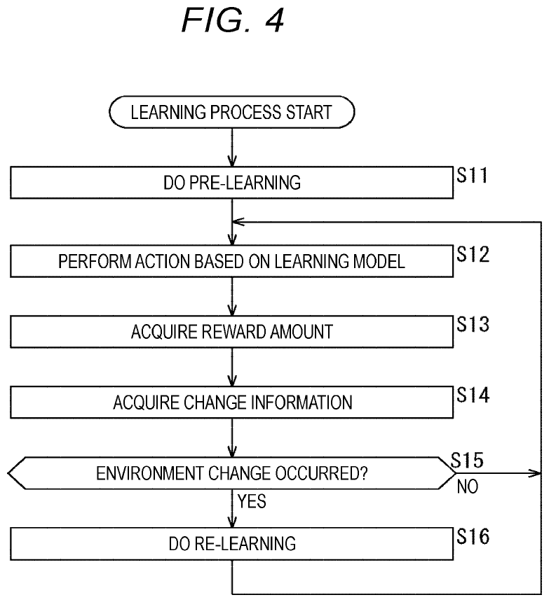

Processing performed by the information processing device 10 for such learning is described below. FIG. 4 is a flowchart for explaining processing performed by the information processing device 10. Individual processes will be described later with reference to specific application examples.

In step S11, pre-learning is done by the pre-learning unit 61 (FIG. 2). The pre-learning is done before the user starts using the information processing device 10 and/or during a predetermined time period after the user starts using the information processing device 10.

For example, in the phase of manufacturing the information processing device 10, for example, in the factory shipment phase, the pre-learning unit 61 does learning in a pseudo environment simulating an environment where the information processing device 10 is in use to generate an initial learning model. The generated initial learning model is stored in the learning model storage unit 63.

Alternatively, the pre-learning period may be set to a predetermined time period after the user starts using the information processing device 10, and an initial learning model may be generated in the pre-learning period and stored in the learning model storage unit 63.

In addition, an initial learning model may be generated before the user starts using the information processing device 10, such as in the factory shipment phase, and then the initial learning model may further be optimized for the mode of use by the user in a predetermined time period after the user starts using the information processing device 10.

The end of the pre-learning period may be a time point when a predetermined time period, such as a time period of one month or a time period until a cumulative time of interaction with the user reaches a predetermined time, has passed. Alternatively, the end of the pre-learning period may be a time point when the change information falls within a certain range, which may be, for example, when the change information is set to 0 because description is given here about an example in which the change information is either 0 or 1.

In step S12, an action is performed on the basis of the learning model (initial learning model) formed through the pre-learning. Specifically, the recognition information acquisition unit 64 (FIG. 2) acquires recognition information, and the output information generation unit 65 generates output information on the basis of the acquired recognition information and of the learning model stored in the learning model storage unit 63.

In step S13, a reward amount is set by the reward amount setting unit 66. The reward amount is set by acquiring the user's reaction or the like to the output information.

In step S14, change information is generated by the change information generation unit 67. The change information generation unit 67 detects that the environment has changed when a sharp change in the reward amount (a sharp increase or decrease in the reward amount) has occurred.

An environment change may be detected when, for example, the variation in the reward amount is equal to or greater than a threshold, which is preset on the information processing device 10 side. In this case, the variation in the reward amount includes both a variation in which the reward amount increases and a variation in which the reward amount decreases, and it is determined whether or not the variation amount is equal to or greater than a threshold.

An environment change may also be detected on the basis of information regarding the environment provided by the user, such as the information indicating that the user has been replaced by a new user or that the installation location has changed to a new location. As a matter of course, these pieces of information may be combined so that an environment change is detected on the basis of the information provided by the user and under the conditions preset in the information processing device 10.

When an environment change is detected, the change information generation unit 67 generates the information “1” indicating that a change has occurred, and supplies the information to the environment change determination unit 68, and when no environment change is detected, the change information generation unit 67 generates the information “0” indicating that no change has occurred, and supplies the information to the environment change determination unit 68.

In step S15, the environment change determination unit 68 determines whether or not an environment change has occurred. In step S15, if the change information supplied from the change information generation unit 67 indicates that no environment change has occurred, the environment change determination unit 68 determines that there is no environment change, and the processing returns to step S12 and the subsequent steps starting from S12 are repeated.

On the other hand, in step S15, if the change information supplied from the change information generation unit 67 indicates that an environment change has occurred, the environment change determination unit 68 determines that an environment change has occurred, and the processing goes to step S16.

In step S16, re-learning is done. When it is determined that an environment change has occurred, the environment change determination unit 68 gives the learning unit 62 an instruction to start re-learning. Upon issuance of such an instruction, the learning unit 62 starts learning. As a result of starting learning, a new learning model is generated or the learning model is updated.

When a new learning model is generated or an update of the learning model is completed as a result of the re-learning done by the learning unit 62, the processing returns to step S12, and the subsequent steps starting from S12 are repeated.

The end of the re-learning period may be a time point when a predetermined time period, such as a time period of one month or a time period until a cumulative time of interaction with the user reaches a predetermined time, has passed. Alternatively, the end of the re-learning period may be a time point when the change information falls within a certain range, which may be, for example, when the change information is set to 0 because description is given here about an example in which the change information is either 0 or 1.

A way of learning done by the information processing device 10 may include continuing the processing without updating the learning model unless it is determined that an environment change has occurred. In such cases, an update of the learning model is started when an instruction to do re-learning is given. During the re-learning, the learning model currently in use may be updated or a new learning model may be generated.

A way of learning done by the information processing device 10 may include continuing the learning so that the learning model is kept optimized. In such cases, when an instruction to do re-learning is given, an update itself of the learning model is continued while leaning is started in a different manner by, for example, redefining the type of the reward or the definition of the evaluation function. Alternatively, a new learning model may be generated.

Note that description is given here about an example in which the change information generation unit 67 and the environment change determination unit 68 are present as shown in FIG. 2; however, the change information generation unit 67 and the environment change determination unit 68 may be combined into a single function. As described with reference to FIG. 3, in a configuration in which the LSTM 82 generates change information (Volatility) and supplies the change information to the LSTM 81, and the LSTM 81 determines whether or not an environment change has occurred so that re-learning is started, the LSTM 82 corresponds to the change information generation unit 67 and the LSTM 81 corresponds to the environment change determination unit 68.

As described above, in a case where the change information generation unit 67 and the environment change determination unit 68 are separately provided, the example in FIG. 3 shows that the same learning method, namely the LSTM 81 and the LSTM 82, is used; however, different learning methods may be used. For example, it is possible to apply a method by which the environment change determination unit 68 corresponds to the LSTM 81 and performs LSTM-based learning, while the change information generation unit 67 performs, for example, an analysis of information provided by a plurality of sensors to detect an environment change or obtains information from the user to detect an environment change.

The change information generation unit 67 and the environment change determination unit 68 may be combined into a single function. According to the above description, the change information generation unit 67 detects an environment change from a change in the reward amount, and supplies the change information of 0 or 1 to the environment change determination unit 68. In this way, the change information generation unit 67 detects an environment change from a change in the reward amount, and thus the change information generation unit 67 performs substantially the same processing as the processing performed by the environment change determination unit 68. Therefore, in another possible configuration, the change information generation unit 67 detects an environment change and, upon detection of an environment change, gives the learning unit 62 an instruction to do re-learning, while the environment change determination unit 68 is not provided.

<About Other Processing Performed by Information Processing Device>

As described above, in a case where re-learning is done and a new learning model is generated when an environment change occurs, the newly generated learning model may be stored in place of the learning model stored in the learning model storage unit 63 by deleting, for example, the initial learning model, or may be additionally stored in the learning model storage unit 63.

In another possible configuration, a plurality of learning models can be stored in the learning model storage unit 63. Furthermore, in still another possible configuration, a plurality of learning models is stored in the learning model storage unit 63, and the learning model to be used is switched among the learning models. As other processing performed by the information processing device, the following describes a case where a learning model is generated and added, and the learning model to be used is switched among the learning models.

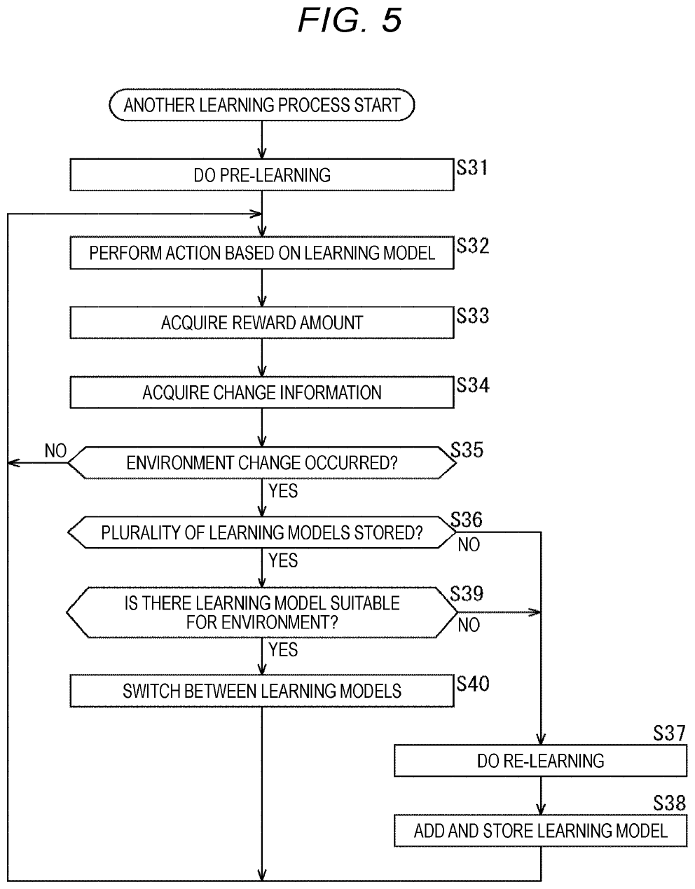

FIG. 5 is a flowchart for explaining other processing performed by the information processing device. The processing in steps S31 to S35 is the same as in steps S11 to S15 (FIG. 4), and thus description thereof is omitted.

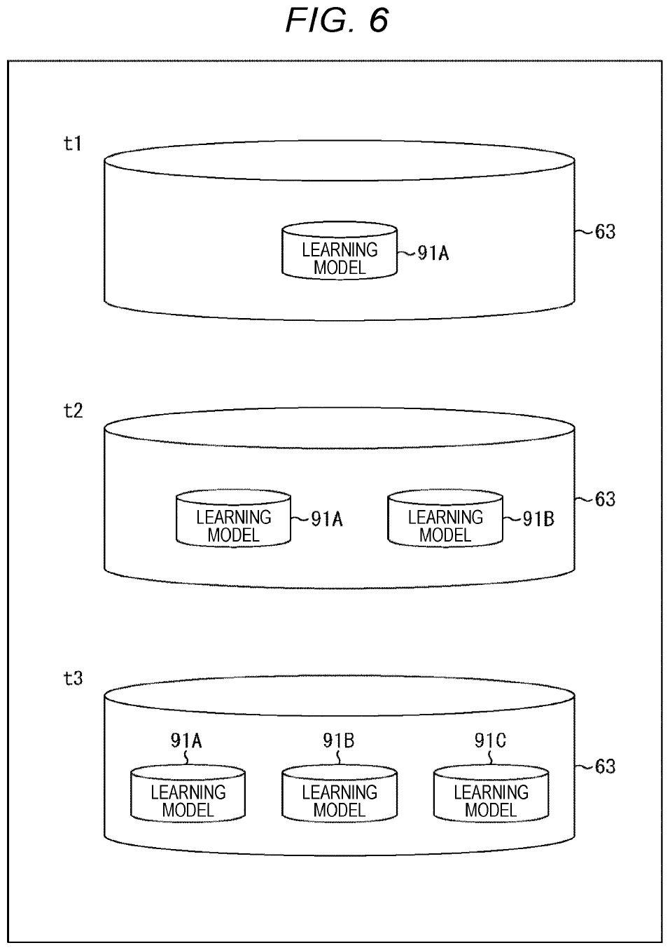

If it is determined in step S35 that an environment change has occurred, the processing goes to step S36. In step S36, it is determined whether or not a plurality of learning models is stored in the learning model storage unit 63. It is assumed here that, as indicated by time t1 in FIG. 6, only the learning model 91A is stored in the learning model storage unit 63.

Furthermore, a learning model stored in any place other than the learning model storage unit 63 may be searched for. For example, in step S35, it may be determined whether or not a learning model managed in a device other than the information processing device 10 can be acquired. In addition, as a result of the determination, if it is determined that the learning model can be acquired, the learning model is also used as the target of the following processing.

In such cases, since the learning model storage unit 63 stores only the learning model 91A, it is determined in step S36 that a plurality of learning models is not stored, and the processing goes to step S37. In step S37, re-learning is done. The processing in step S37 can be performed in a similar manner to the manner in step S16 (FIG. 4), and thus description thereof is omitted.

Note that, however, re-learning is done in step S37, with the result that a learning model different from the already stored learning model (the learning model 91A, for example) is newly generated. In other words, without updating the learning model 91A, or even if the learning model 91A is supposed to be updated, a learning model (learning model 91B) different from the learning model 91A is generated while the learning model 91A itself is left as it is.

The learning model newly generated by doing re-learning in step S37 is added to and stored in the learning model storage unit 63 in step S38. For example, as indicated by time t2 in FIG. 6, as a result of the processing in step S38, the learning model 91A and the learning model 91B are stored in the learning model storage unit 63.

After the processing in step S38, the processing returns to step S32 and the subsequent steps starting from S32 are repeated. In the present case, process steps based on the learning model 91B are executed.

On the other hand, if it is determined in step S36 that a plurality of learning models is stored in the learning model storage unit 63, the processing goes to step S39. For example, if the learning model 91A and the learning model 91B are stored in the learning model storage unit 63 as indicated by time t2 in FIG. 6, it is determined that a plurality of learning models is stored in the learning model storage unit 63 in the determination in step S36.

In step S39, it is determined whether or not there is a learning model suitable for the environment. For example, suppose that a learning model optimized for an environment A is the learning model 91A and a learning model optimized for an environment B is the learning model 91B. In a case where it is determined that an environment change has occurred and it can be determined that the post-change environment is the environment A, in step S39, a learning model suitable for the environment is regarded as stored in the learning model storage unit 63, and the processing goes to step S40.

In step S40, the referenced learning model is switched to the learning model that has been determined to be suitable for the environment after the environment change, and the processing returns to step S32, whereby the processing based on the learning model is started.

On the other hand, in a case where it is determined that an environment change has occurred and that the post-change environment is an environment C, which is different from the environments A and B, in step S39, a learning model suitable for the environment is not regarded as stored in the learning model storage unit 63, and the processing goes to step S37.

In step S37, re-learning is done. In this case, a learning model optimized for the environment C is learned. Then, in the process step of step S38, a newly generated learning model 91C is added to and stored in the learning model storage unit 63 (reaching the state illustrated in time t3 of FIG. 6).

That is, in a case where an environment change has occurred, if there is a learning model suitable for the post-change environment, the processing is switched to the processing based on that learning model, and if there is no learning model suitable for the post-change environment, a learning model suitable for the post-change environment is generated and added.

For example, suppose that the environment A is an environment in which interaction with the user A takes place and the learning model 91A is a learning model optimized for the user A. Furthermore, suppose that the environment B is an environment in which interaction with the user B takes place and the learning model 91B is a learning model optimized for the user B.

As long as the interaction with the user A takes place with reference to the learning model 91A, it is determined that there is no environment change, and thus the processing referring to the learning model 91A is continued. When the interaction partner changes from the user A to the user B, there is a possibility that the user B is not satisfied with the interaction being made with reference to the learning model 91A and the reward amount decreases. Upon a decrease in the reward amount, it is detected that an environment change has occurred.

When it is detected that the environment has changed, the learning model storage unit 63 is searched to find whether or not a learning model suitable for the environment is stored therein. In the present case, the learning model 91B optimized for the user B is stored, and therefore, as a result of the search, it is determined that the learning model 91B is stored. Consequently, the referenced learning model is switched to the learning model 91B. Then, the interaction with the user B with reference to the learning model 91B is started. Therefore, the reward amount returns to the original amount and the state prior to the determination that an environment change has occurred is restored.

In this way, a plurality of learning models can be stored to perform the processing with reference to an optimal learning model.

In step S39, a determination of whether or not there is a learning model suitable for the environment is made. This determination is further described below. In one example, the environment can be recognized on the basis of information provided by a sensor. In the case of the above example, the user can be identified by capturing an image of the user and analyzing the captured image. In addition, the user can be identified by acquiring and analyzing the user's voice.

For example, when it is determined, as a result of the analysis, that interaction with the user B is taking place, the referenced learning model is switched to the learning model 91B for the user B. Furthermore, when an unregistered user is detected as a result of analyzing an image or voice, re-learning is done so as to generate a learning model for that user.

In another example, it is determined whether or not a learning model is suitable for the environment by switching between the learning models stored in the learning model storage unit 63 and observing a change in the reward amount between the learning models. Suppose that an environment change has been detected because of, for example, the interaction partner has changed from the user A to the user B as in the above example.

Then, when the learning model is switched from the learning model 91A to the learning model 91B and interaction takes place, the original reward amount is restored, and thus it can be inferred that the learning model has been switched to a correct learning model. On the other hand, when the learning model is switched from the learning model 91A to the learning model 91C and interaction takes place, the reward amount remains low, and thus it can be inferred that the learning model has not been switched to a correct learning model.

In this way, it may be determined whether or not the learning model has been switched to a correct learning model by switching between learning models stored in the learning model storage unit 63 and observing a change in the reward amount.

In addition, examples of the environment change for which learning models are switched may include a change in time zone, a change in timing, a change in weather, a change in location, and the like. For example, the referenced learning model may differ depending on the time zone, and when it becomes a predetermined time zone, which is regarded as an environment change, learning models may be switched.

### First Application Example

An application example of the above-described information processing device 10 will now be described. The following mainly describes, as an example, the case of performing the processing of the flowchart shown in FIG. 4, that is, the case where learning models are not switched; however, the following description can be applied to the case of performing the processing of the flowchart shown in FIG. 5 in which learning models are switched.

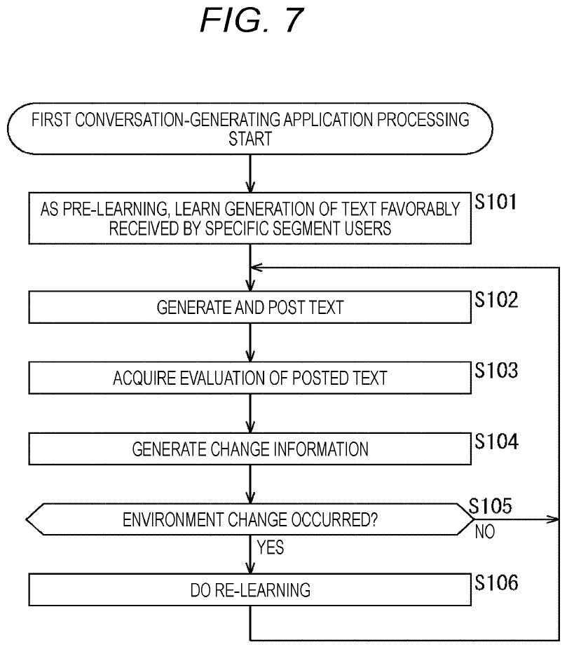

The following describes a first application example with reference to the flowchart shown in FIG. 7. In the first application example, the present technology is applied to, as an application, a system that generates conversations and text, such as a chatbot. A chatbot is an automatic conversation program that utilizes artificial intelligence, allowing a computer incorporating artificial intelligence to have conversations on behalf of humans. The information processing device 10 can be applied to the computer on which a chatbot runs.

In the case of doing reinforcement learning involved with a chatbot, the action is generating a conversation (text) and presenting the generated conversation (text) to the user, and the reward amount is the user's reaction or like to the presented conversation (text). In addition, the re-learning is re-learning a learning model for generating a conversation (text).

In step S101, pre-learning is done. In a case where the application is an application that automatically generates, for example, a message to be posted to a social network service (SNS), messages highly rated by the target user or users are learned as pre-learning. For example, a plurality of messages is posted in a test environment to learn generation of text that is favorably received by specific segment users. Examples of the specific segment users include users belonging to a predetermined age group such as 30s or 40s, users belonging to a predetermined group having common attributes such as preference or behavioral tendencies, users living in a predetermined area, and the like.

Through the pre-learning, an initial learning model is generated and stored in the learning model storage unit 63. When an initial learning model is stored in the learning model storage unit 63, in step S102, text is generated and posted with reference to the initial learning model. That is, the processing with reference to the learning model is actually performed. As the recognition information (Perceptual Data) that is input when text is generated, the number of views of a posted message, the number of followers added to a posted message, evaluation of a posted message such as good or bad, and the number of transfers of a posted message, for example, are acquired. In addition, time information such as a time zone in which a posted message is viewed, a profile of the user who makes an evaluation or transfers a posted message, and the like may be acquired.

In step S103, when text is posted, an evaluation of the posted text, that is, information corresponding to the reward amount in the present case, is acquired. The reward amount is set on the basis of the information including evaluations, transfers, the number of views, and the like made by the specific segment users. A higher reward amount is set when, for example, the specific segment users make higher evaluations, the number of transfers is larger, the number of views is larger, and so on. In contrast, a lower reward amount is set when, for example, the specific segment users make lower evaluations, the number of transfers has decreased, the number of views is smaller, and so on.

In step S104, change information is generated by observing an increase/decrease in the reward amount. When the reward amount has increased or decreased, the change information (in the present case, the information of 1) indicating that a change has occurred is generated. Note that a threshold may be preset, and it may be determined that a change has occurred when the reward amount has increased or decreased by an amount equal to or greater than the preset threshold. Furthermore, an increase/decrease in the reward amount may be limited to a variation within a predetermined time period, and the time period in which an increase/decrease in the reward amount is observed may be set in advance.

Basically, learning is done so as to increase the reward amount, and thus the reward amount increases as long as a suitable learning is done. Therefore, an observation is made under the condition that the reward amount has increased by a predetermined amount in a predetermined time period, not that the reward amount has merely increased. For example, when the reward amount has increased in a short time period, it can be determined that the reward amount has sharply increased, and in such cases, it can be inferred that some change has occurred to the environment.

In the following description, a sharp increase represents the case where the reward amount has increased by a predetermined amount (threshold) within a predetermined time period. In other words, an increase in the reward amount by the amount or at the rate equal to or greater than a predetermined amount per unit time is described as a sharp increase.

In addition, a sharp decrease represents the case where the reward amount has decreased by a predetermined amount (threshold) within a predetermined time period (unit time). In other words, a decrease in the reward amount by the amount or at the rate equal to or greater than a predetermined amount per unit time is described as a sharp decrease. In the present embodiment, such sharp increase or sharp decrease in the reward amount is detected, but an increase or decrease in the reward amount due to successful progress of learning is not detected.

In step S105, it is determined whether or not an environment change has occurred. If the change information is information indicating that an environment change has occurred (1 in the present case), the determination of YES is made, and if the change information is information indicating that no environment change has occurred (0 in the present case), the determination of NO is made.

In step S105, if the change information is information indicating that no environment change has occurred, the processing returns to step S102, and the subsequent steps starting from S102 are repeated. On the other hand, in step S105, If the change information is information indicating that an environment change has occurred, the processing goes to step S106.

In step S106, re-learning is done.

Regarding a case where the reward amount has sharply increased, it can be inferred that some causes thereof, for example, growing support from new segment users, are present. For example, it can be inferred that the reward amount may sharply increase because awareness in the targeted specific segment users spread and, by some trigger, the spread reaches non-targeted specific segment users. In such cases, re-learning is done so that the target is changed to the newly acquired specific segment user group or that messages to be additionally accepted by the newly acquired specific segment user group (a wider segment layer) can be posted.

Regarding a case where the reward amount has sharply decreased, it can be inferred that some causes thereof, for example, an inappropriate message posted, are present. For example, it can be inferred that support from the specific segment users has fallen to cause a sharp decrease in the reward amount because, for example, text including a word unpleasant to the target specific segment users or a word making the users unsympathetic was posted. In such cases, re-learning is done so that the reward for a group of posted messages that may become a cause (a plurality of posted messages including a word that presumably decreases support from the users) and for the word used for generating a posted message is set to a negative reward.

In this way, re-learning can be done such that the reward is redefined in accordance with the information regarding an environment change and that an appropriate reward is given.

Note that, although description has been given here about an example in which a message is posted aiming at specific segment users as a target, the present technology can be applied to a posted message that is not intended for any specific segment users.

For example, when the reward amount has sharply increased, it can be inferred that the posted messages causing the sharp increase in the reward amount contain a word or expression pleasant to the users, and re-learning can be done such that messages that use such word or expression are further posted. In addition, when the reward amount has sharply decreased, it can be inferred that the posted messages causing the sharp decrease in the reward amount contain a word or expression unpleasant to the users, and re-learning can be done such that the reward for posted messages that include such word or expression is redefined.

As described above, re-learning is done when the reward amount has sharply increased. In other words, re-learning is not started as long as the reward amount has not sharply increased. If the reward amount has not sharply increased, the learning intended to increase the reward amount is continued.

The same applies to the following embodiments. In addition, in some of the following embodiments, re-learning is done when the reward amount has sharply decreased, and the learning intended to increase the reward amount is continued if the reward amount has not sharply decreased.

Through the re-learning, the learning model prior to the re-learning is modified into an appropriate learning model or a new learning model is generated. The re-learning is defined as learning intended to significantly change the learning model prior to the re-learning.

After the re-learning, the learning model resulting from the re-learning is used to continue the learning intended to increase the reward amount. The learning model resulting from the re-learning is a learning model suitable for the current environment, and therefore, the learning model resulting from the re-learning is a learning model that prevents a sharp increase or decrease in the reward amount, in other words, a learning model for gradually increasing the reward amount in the state where a variation in the reward amount falls within a predetermined range. According to the present technology, when an environment change has occurred, a learning model suitable for the environment can be generated.

### Second Application Example

A second application example of the above-described information processing device 10 is described below.

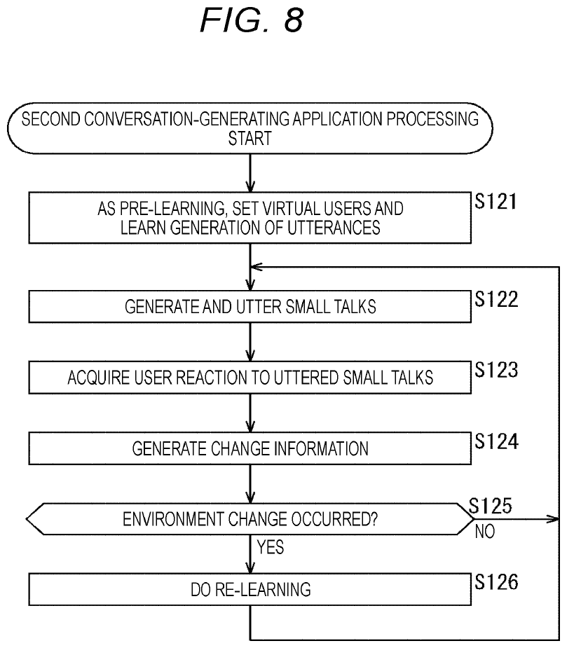

The following describes the second application example with reference to the flowchart shown in FIG. 8. The second application example is the same as the first application example in that the present technology is applied to, as an application, a chatbot that generates conversations, but is different from the first application example in that the present technology is applied to a case where small talks are generated.

In step S121, pre-learning is done. In a case where the application is an application that implements a conversation function of a home AI agent and that generates, for example, innocuous small talks, a pseudo conversation is held with users as pre-learning and specific conversations highly rated by the users are learned.

For example, a conversation is held with virtual users in a test environment to generate utterances, whereby learning is done. As the virtual users, users satisfying specific conditions, such as users belonging to a predetermined age group like 30s or 40s, users belonging to a predetermined group, or users living in a predetermined area, may be set. Alternatively, learning intended to establish a general conversation may be done without setting such specific conditions.

In addition, a pre-learning period, which is a predetermined time period after a general (commonly used) learning model is generated by pre-learning and the user actually starts using the information processing device 10, may be provided and learning may be done during the pre-learning period.

In step S122, a conversation is generated and uttered with reference to the learning model. That is, the processing with reference to the learning model is actually performed. The recognition information (Perceptual Data) that is input when a conversation is generated is, for example, environment information such as time and temperature, a profile of the user, a response given by the user, an emotion of the user, event information, and the like.

In step S123, upon giving utterance of a conversation, a reaction given by the user to the utterance is acquired. The user's reaction is acquired as a reward. Examples of the user's reaction include affect, emotion, and a specific response. Here, the condition, affect, and emotion of the user can be estimated on the basis of a facial expression recognized by a camera, biological sensing, voice prosody, and the like, and the affect includes the degree of stress, the level of satisfaction, and the like.

In step S124, change information is generated by observing an increase/decrease in the reward amount. The reward amount sharply decreases when, for example, the user's reaction becomes negative. For example, when the user has a weaker smile or shows an unusual reaction to a similar topic presented, it is inferred that the user's reaction has become negative, and the reward amount is decreased. When the reward amount has sharply increased or decreased, the change information indicating that a change has occurred is generated. A threshold and a certain time period may be preset, and it may be determined that a change has occurred when the reward amount has increased or decreased by an amount equal to or greater than the preset threshold within the time period.

In step S125, it is determined whether or not an environment change has occurred. In step S125, if the change information is information indicating that no environment change has occurred, the processing returns to step S122, and the subsequent steps starting from S122 are repeated. On the other hand, in step S125, if the change information is information indicating that an environment change has occurred, the processing goes to step S126. In step S126, re-learning is done.

Regarding a case where the reward amount has sharply decreased, it can be inferred that some causes thereof, for example, an inappropriate topic presented, are present. For example, it can be inferred that the user's reaction became negative and the reward amount has sharply decreased because a conversation that makes the user uncomfortable or sad was made.

For example, in a case where the user has suffered a bereavement, it can be inferred that the user gives a favorable reaction when a topic about relatives is presented before the bereavement, but the user gives a negative reaction (no smile, a sad facial expression, a lower voice tone, a response asking not to present the topic, and the like) when a topic about relatives is presented after the bereavement.

In such cases, re-learning is done so as not to present a topic about relatives to the user. In other words, in order to cope with new affairs of the user, the re-learning intended to adapt to the new environment of the user is done. In the present case, the reward is redefined and re-learning is done so that the reward amount for a topic about relatives is reduced.

In addition, for example, in a case where the user has moved from an area A to an area B, it is inferred that the user gives a favorable reaction when a topic about the area A is presented to the user before the move, but the user gives a response showing no interest when a topic about the area A is presented after the move. In such cases, re-learning is done so as not to present a topic about the area A but to present a topic about the area B.

Regarding a case where the reward amount has sharply increased, it can be inferred that some causes thereof are present, for example, the fact that the user now feels better because a change pleasant to the user has occurred in the family members or lifestyle of the user. For example, in a case where a child of the user has been born, it is inferred that the user gives a reaction showing no interest when a topic about a child is presented before the birth of the child, but in contrast the user gives a reaction showing interest when a topic about a child is presented after the birth of the child.

In such cases, re-learning is done so as to present a topic about children to the user. In the present case, the reward is redefined and re-learning is done so that the reward amount for a topic about children is increased.

In this way, re-learning can be done such that the reward is redefined in accordance with the information regarding an environment change and that an appropriate reward is given.

### Third Application Example

A third application example of the above-described information processing device 10 is described below.

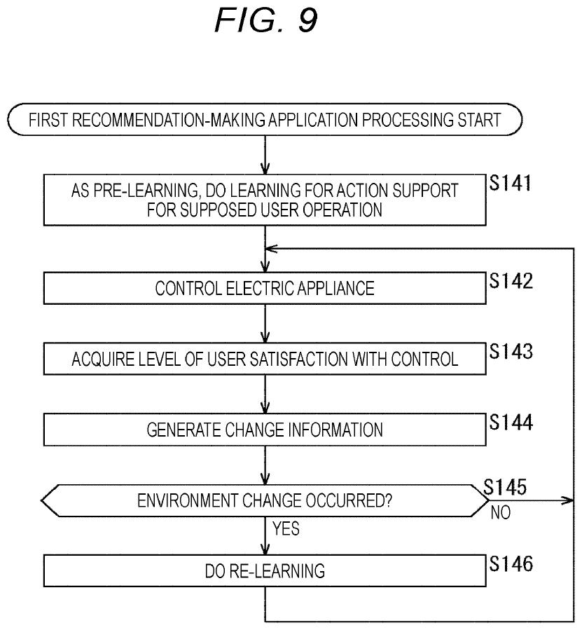

The following describes the third application example with reference to the flowchart shown in FIG. 9. In the third application example, the present technology is applied to an application that gives a recommendation to a user. In addition, in the third application example, description is given about, as the third application example, an application implementing home automation for performing control, for example, to turn on the light in a place to which the user is to move, to power on the television receiver in anticipation of a user action, or to adjust the room temperature to a temperature at which the user feels comfortable.

Note that description is given here about the case of controlling an electric appliance as an example and the electric appliance includes, for example, a driving device for opening and closing a window or curtain.

In the case of doing reinforcement learning involved with a recommendation, the action is presenting a recommendation to the user, and the reward amount is the user's reaction or the like to the presented recommendation. In addition, the re-learning is re-learning a learning model for making a new recommendation dependent on a change in the user's conditions.

In step S141, pre-learning is done. For example, a learning model is generated through pre-learning in a manufacturing process in a factory. Furthermore, in the case of home automation, the position of a light, action patterns of the user, and the like are different among users. Therefore, a predetermined time period after the user starts using the information processing device 10 is additionally set as the pre-learning period, and learning is continued in the state where the user is actually using the information processing device 10.

For example, while the user is moving inside a house, learning is done by which user actions are sensed by a sensor, the destination to which the user will move is estimated, and the light at the estimated destination is turned on. In addition, for example, learning is done by which the user's time to come home is learned and the light at the entrance is turned on at the time when the user will come home. Furthermore, for example, learning is done by which the user's habit of viewing a TV program of a certain channel on a television receiver upon wake-up is learned and the television receiver is powered on at the user's wake-up time.

In this way, the pre-learning intended to support user actions is done to generate a learning model.

In step S142, support for user actions is provided with reference to the learning model. In the present case, an electric appliance is controlled as the support for user actions. The recognition information (Perceptual Data) that is input for providing support for actions is, for example, daily user actions, information obtained from electric appliances, and the like. The information obtained from electric appliances includes, for example, the time when a light is turned on or off, the time when a television receiver is powered on or off, the room temperature or preset temperature at the time when an air conditioner is turned on, and the like.

In step S143, upon control of an electric appliance, a reaction given by the user to the control is acquired. The user's reaction is acquired as a reward. Reactions given by the user include, for example, the amount of stress or the level of satisfaction estimated by sensing the user, the number of times that the user cancels what is controlled, the number of user actions inferred to be useless, and the like.

The number of times that the user cancels what is controlled is, for example, the number of times that the user turns off a light immediately after the light is turned on or that the user turns on a light immediately after the light is turned off, or the number of times that the user gives an instruction contrary to what is controlled, that is, the number of times the user gives an instruction intended to cancel a controlled thing.

In step S144, change information is generated by observing an increase/decrease in the reward amount. The reward amount sharply decreases when, for example, the user cancels what is controlled many times.

In step S145, it is determined whether or not an environment change has occurred. In step S145, if the change information is information indicating that no environment change has occurred, the processing returns to step S142, and the subsequent steps starting from S142 are repeated. On the other hand, in step S145, if the change information is information indicating that an environment change has occurred, the processing goes to step S146. In step S146, re-learning is done.

Regarding a case where the reward amount has sharply decreased, it can be inferred that, for example, the control of an electric appliance was satisfactory to the user before the sharp decrease in the reward amount, but the control of the electric appliance has become unsatisfactory to the user after the sharp decrease. For example, it can be inferred that the reward amount has sharply decreased because the user had a job switch, a relocation, a diversion, a change in family members, or the like, and action patterns are no longer the same as those before the change.

In such cases, re-learning is done to adapt to a new life pattern of the user. Furthermore, when a probable cause of the change in life pattern can be inferred during re-learning, the re-learning may be done on the basis of the inference result. For example, if it is inferred that the lifestyle pattern has changed due to an increase in the number of children, the re-learning may be done by applying a lifestyle model of a person having an increased number of children.

The inference that the life pattern has changed may be made by observing an action pattern of the user at the time when the reward amount has sharply decreased (when the change information indicates that a change has occurred). For example, in a case where a light is more often turned on during nighttime due to night-time crying of a child, the reward amount sharply decreases because the light is turned on during a time zone when the light was not turned on before the increase in the number of children. On the basis of the sharp decrease in the reward amount and of the action pattern of turning on the light at night more frequently, it can be inferred that the number of children has increased.

As described above, the circumstances in which an environment change has occurred may be inferred from the reward or the reward and environment variables. Furthermore, in order to make such inference, the reward may be a vector value instead of a scalar value.

### Fourth Application Example

A fourth application example of the above-described information processing device 10 is described below.

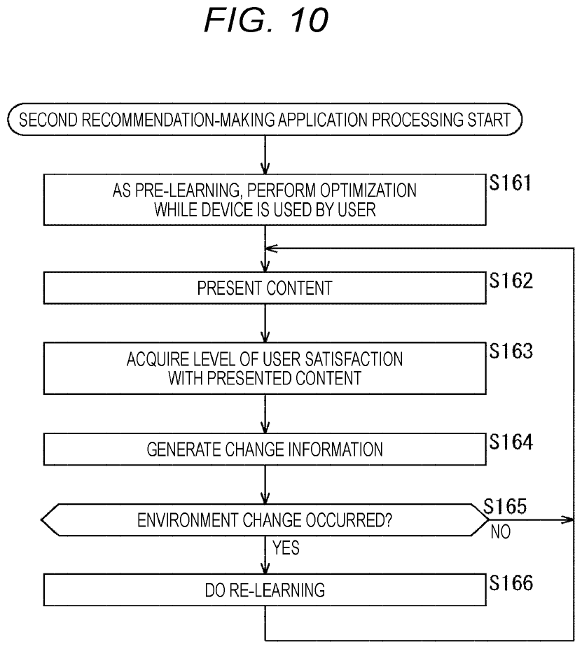

The following describes the fourth application example with reference to the flowchart shown in FIG. 10. In the fourth application example, the present technology is applied to an application that gives a recommendation to a user. In addition, as the fourth application example, description is given about an application that presents (recommends) content to the user.

In step S161, pre-learning is done. In the case of presenting content to the user, a predetermined time period after the user starts using the information processing device 10 is set as the pre-learning period in order to learn preferences of the user because preferences differ among users, and learning (optimization) is continued in the state where the user is actually using the information processing device 10.

In step S162, a recommendation is made to the user with reference to the learning model. The recognition information (Perceptual Data) that is input for recommending content is, for example, user segment information, user actions, a social graph, and the like. In addition, the user actions include not only a history of actions in the real world but also a history of actions and a history of viewing/listening on the Web.

In step S163, upon recommendation of content, a reaction given by the user to the recommendation is acquired. The user's reaction is acquired as a reward. The user's reaction is acquired by, for example, finding presence or absence of the target action such as viewing or purchasing the recommended content, or estimating the level of user satisfaction through user sensing.

In step S164, change information is generated by observing an increase/decrease in the reward amount. The reward amount sharply decreases when, for example, the estimated level of user satisfaction falls or the number of times that content is purchased decreases.

In step S165, it is determined whether or not an environment change has occurred. In step S165, if the change information is information indicating that no environment change has occurred, the processing returns to step S162, and the subsequent steps starting from S162 are repeated. On the other hand, in step S165, if the change information is information indicating that an environment change has occurred, the processing goes to step S166. In step S166, re-learning is done.

If the reward amount has sharply decreased, re-learning is done so that content belonging to a genre different from the genre previously recommended is recommended. In addition, if the reward amount has sharply increased, the genre to which the content recommended during the sharp increase belongs is regarded as popular with the user, and re-learning is done so that content belonging to that genre is preferentially recommended.

Furthermore, in the case of content recommendation, re-learning may be done when the reward amount is increasing or decreasing only to a small extent, in other words, when the change information keeps indicating no change for a certain period of time. When the reward amount is increasing or decreasing only to a small extend, it can be inferred that recommendations are made according to a learning model optimal for the user; however, there is a possibility that recommendations are made without surprise.

Therefore, re-learning may be done so that an unexpected recommendation is made. In this case, the re-learning may be done after the learning model is reset. In this case, the learning model prior to the re-learning may remain stored in the learning model storage unit 63 so as to be stored in the learning model storage unit 63 together with a newly created learning model. As described with reference to FIGS. 5 and 6, a plurality of learning models may be stored in the learning model storage unit 63 and, if the reward amount keeps decreasing when recommendations are made in accordance with a newly created learning model, the original model may be used again.

As described above, when the reward amount increases or decreases stagnantly, in other words, when the change information indicating no change is successively generated for a certain period of time, a tendency to make similar inferences can be recognized, which means, for example, seemingly the recommendations are causing the same user reactions all the time. In such cases, re-learning may be done for changing the learning model in order to assure unexpectedness and serendipity.

Such re-learning is also effective as means for escaping from the state of over-training.

### Fifth Application Example

A fifth application example of the above-described information processing device 10 is described below.

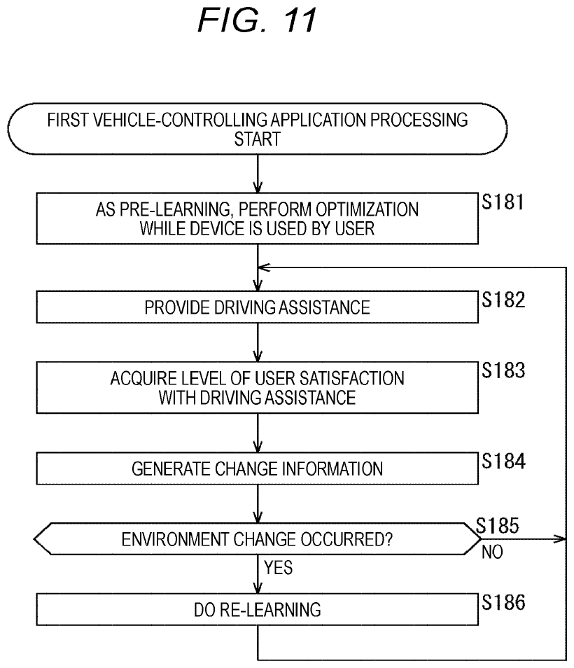

The following describes the fifth application example with reference to the flowchart shown in FIG. 11. In the fifth application example, the present technology is applied to, as an application, control of a moving object such as a vehicle. In addition, as the fifth application example, description is given about, for example, an application that provides driving assistance to the user (driver). The driving assistance is assisting the driver in comfortably driving a vehicle, such as, for example, braking control of the vehicle, steering wheel operation control, setting an environment of the vehicle interior, and the like.

In the case of doing reinforcement learning involved with control of a moving object, the action is controlling the moving object (vehicle), and the reward amount is an emotion of the user operating the controlled moving object, environment information relating to the moving object, and so on. In addition, the re-learning is re-learning a learning model for controlling the moving object.

In step S181, pre-learning is done. In the case of an application that provides driving assistance, since preferences regarding driving such as a selected driving course, acceleration, and steering as well as preferences regarding an environment in the vehicle such as a temperature in the vehicle are different among individual users, the pre-learning period is set to a predetermined time period after the user starts using the information processing device 10 and the pre-learning is done during the period.

In step S182, driving assistance is provided with reference to the learning model. That is, the processing with reference to the learning model is actually performed. The recognition information (Perceptual Data) that is input when driving assistance is provided is, for example, various types of data acquired during driving. As the data, data in Controller Area Network (CAN) can be used. CAN is a network used for connecting components such as an electronic control unit (ECU: engine control unit), an engine, and a brake inside an automobile, communicating the states of components, and transmitting control information. Information from such a network can be used as recognition information.

In step S183, the level of user satisfaction with the driving assistance is acquired. The user's reaction is acquired as a reward. For example, a variable representing the comfort of the driver may be defined, and the variable based on the definition may be used as the reward amount. In addition, the stability of the vehicle, the user's biological information, and emotion and affect information estimated from the biological information and the like may be acquired as the reward amount.

For example, the reward amount sharply decreases when the user performs an operation for canceling specific assistance, for example, when the vehicle is decelerated by the user after accelerated by the driving assistance, or when the preset temperature inside the vehicle is lowered by the user after a setting to raise the temperature is made. In addition, the reward amount also sharply decreases when the user's biological information, such as the information indicating that the user is sweating, is acquired, and it is inferred that the user reaction is unfavorable because the temperature inside the vehicle as preset by the driving assistance is high.

On the other hand, the reward amount sharply increases when, for example, it is determined that driving has been stabilized by driving assistance, such as a reduced lurch of the vehicle, disappearance of abrupt acceleration and abrupt deceleration, and the like.

In step S184, change information is generated by observing an increase/decrease in the reward amount. The reward amount sharply decreases when, for example, driving becomes less stable or the user's reaction becomes negative.

In step S185, it is determined whether or not an environment change has occurred. In step S185, if the change information is information indicating that no environment change has occurred, the processing returns to step S182, and the subsequent steps starting from S182 are repeated. On the other hand, in step S185, if the change information is information indicating that an environment change has occurred, the processing goes to step S186. In step S186, re-learning is done.

For example, in a case where the driver is injured and is driving in a different way than before, and the driving assistance is no longer suitable for the driver, resulting in a sharp decrease in the reward amount, the re-learning is done for generating a learning model suitable for the injured driver.

Furthermore, for example, there may be cases where another driver is driving the vehicle and the driving assistance is no longer suitable, resulting in a sharp decrease in the reward amount. In such cases, re-learning is done so as to provide driving assistance suitable for the new driver.

The driving assistance is intended for safe driving of the vehicle. For example, on the basis of whether or not the information processing device 10 providing such driving assistance is installed (is in use), the insurance premium for the vehicle may be estimated. In addition, details of the driving assistance, such as, for example, information relating to an environment change at a time when it is determined that re-learning is to be done may be used to estimate the insurance premium.

### Sixth Application Example

A sixth application example of the above-described information processing device 10 is described below.

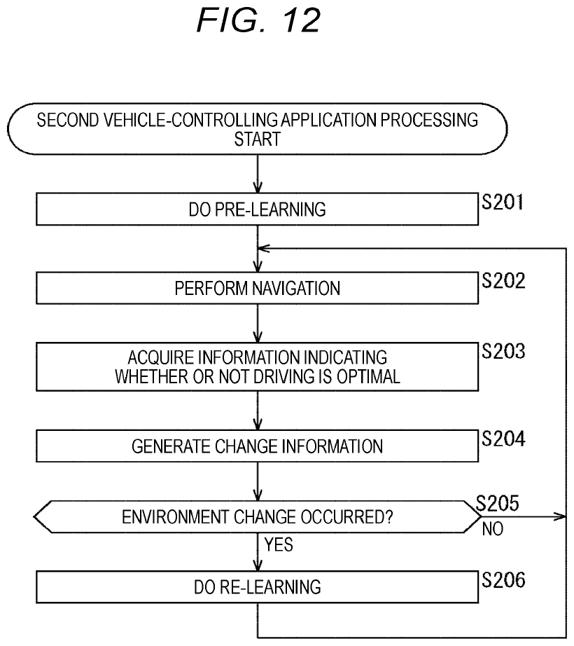

The following describes the sixth application example with reference to the flowchart shown in FIG. 12. In the sixth application example, the present technology is applied to, as an application, management of a plurality of vehicles (control of a group of vehicles).

For example, a vehicle equipped with a function of constantly connecting to the Internet, called a connected car, is available. Such a connected car is configured to be able to acquire information via the Internet, and thus is capable of, for example, navigation, movement control, management, and so on in accordance with traffic information. The application (the information processing device 10 that operates on the basis of the application) in the sixth application example can be applied to cases where navigation, movement control, management, and so on in accordance with traffic information are performed in a connected car.

In addition, the application (the information processing device 10 that operates on the basis of the application) in the sixth application example can be applied to, for example, management of public transportation including buses and taxis, management of shared cars that are centrally managed, management of vehicles associated with specific services (rental cars, for example), and the like.

In step S201, pre-learning is done. As the pre-learning, a management method and the like, which can be set to some extent before the operation is started, are set. Furthermore, the learning is continued after the operation is started because details of the learning are different among managed vehicles, services, and the like.

In step S202, management is performed with reference to the learning model. That is, the processing with reference to the learning model is actually performed. The recognition information (Perceptual Data) that is input when vehicles are managed includes, for example, daily environment information, traffic information, weather information, and the like. In addition, information regarding events may be acquired as the recognition information because traffic congestion is likely to occur on the day of an event or the like.

Furthermore, position information, driving information, and the like regarding various vehicles under management may be acquired. Moreover, customer information may be acquired.

In step S203, information indicating, for example, whether or not the driving is optimal is acquired. The information is acquired as a reward. For example, in a case where traffic congestion information is acquired and navigation for avoiding the traffic congestion is performed, it can be inferred that a correct prediction was made if the vehicle has reached the destination in a short time without being caught in a traffic jam. In such cases, the reward amount sharply increases. In contrast, the reward amount sharply decreases if it takes much time to reach the destination.

In addition, in the case of a bus or the like, the reward amount becomes higher if the bus is running in accordance with the operation schedule, while the reward amount becomes lower if the bus is not running in accordance with the operation schedule. In addition, when the volume of traffic congestion in the area (referred to as a target area) where managed vehicles are running has decreased, it can be inferred that the individual vehicles were not involved in the traffic congestion as a result of appropriate management of the managed vehicles and that the traffic congestion in the target area has decreased. In such cases, the reward amount increases. To the contrary, when the traffic congestion in the target area has increased, the reward amount may be allowed to decrease even if the individual vehicles are not involved in the traffic congestion.

In step S204, change information is generated by observing an increase/decrease in the reward amount.

In step S205, it is determined whether or not an environment change has occurred. In step S205, if the change information is information indicating that no environment change has occurred, the processing returns to step S202, and the subsequent steps starting from S202 are repeated. On the other hand, in step S205, if the change information is information indicating that an environment change has occurred, the processing goes to step S206. In step S206, re-learning is done.

For example, in a case where a road is closed for a construction work, causing an environment change in which traffic congestion is more likely occur in the vicinity thereof, there is a possibility that vehicles under management according to a learning model prior to the construction work are involved in the traffic congestion, with the result that the reward amount decreases. In addition, in a case where a new commercial facility or office building is constructed, causing an environment change in which a larger number of people are present in the vicinity thereof and traffic congestion is more likely to occur, or in which a larger number of people are moving in the vicinity thereof by public transportation, there is a possibility that the reward amount decreases if the vehicles are managed according to a learning model prior to the construction of a building.

In such cases, re-learning is done so as to avoid congested roads and time zones in which traffic congestion is likely to occur. In addition, in a case where it is inferred that the number of users of public transportation has increased, re-learning is done so as to increase the number of transportation services in a route in which the number of users has increased.

Quick re-learning to adapt to a new environment may be facilitated by temporarily reinforcing reward-based feedback. Learning is continued so as to flexibly cope with an environment change, while the feedback on a dramatic change in the reward amount is further reinforced, whereby more flexible and quick re-learning can be facilitated.

Note that it is conceived that road closure or the like due to a construction work is temporary and the original state is recovered after the construction work. In order to cope with such temporary environment change, the learning model prior to the environment change (the learning model prior to re-learning) may remain stored in the learning model storage unit 63 so as to be stored in the learning model storage unit 63 together with a newly created learning model. As described with reference to FIGS. 5 and 6, a plurality of learning models may be stored in the learning model storage unit 63 and, if the environment has changed upon completion of a construction work, the original model may be used again.

### Seventh Application Example

A seventh application example of the above-described information processing device 10 is described below.

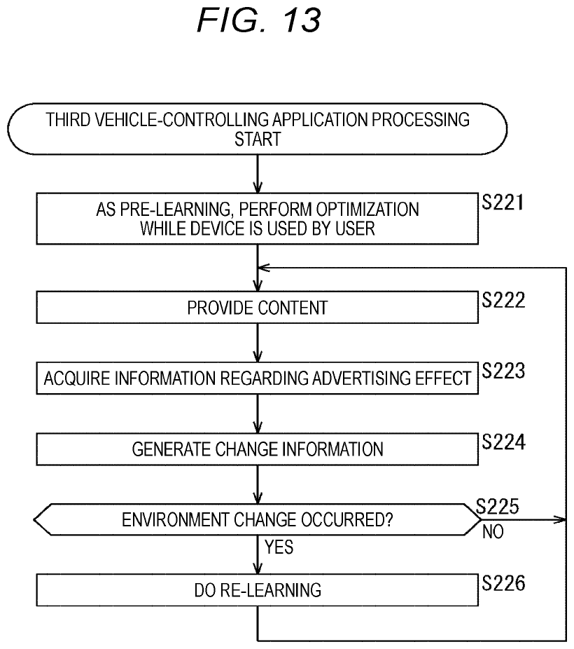

The following describes the seventh application example with reference to the flowchart shown in FIG. 13. In the seventh application example, the present technology is applied to, as an application, management of a plurality of vehicles (control of a group of vehicles). In addition, description is given about an example in which an application provides mobility-related content in a vehicle. Note that, although the description given here assumes that vehicles are mainly cars, the vehicles include trains, ships, airplanes, and so on.

For example, the application (the information processing device 10 that operates on the basis of the application) in the seventh application example provides, in a vehicle such as the public transportation including buses and taxis, a shared car, or a vehicle associated with a specific service (rental car, for example), certain content to users of the vehicle, such as an advertisement, a discount ticket for using the vehicle, or a discount ticket for a commercial facility located in a surrounding area.

In step S221, pre-learning is done. It is conceived that more effects of providing content are obtained if the provided content matches the target age group, the user preferences, or the like. As the pre-learning, general learning is done before the operation is started, and learning for optimization for users of the vehicle is done after the operation is started.

In step S222, content is provided with reference to the learning model. That is, the processing with reference to the learning model is actually performed. The recognition information (Perceptual Data) that is input when content is provided includes, for example, daily environment information, traffic information, weather information, and the like. In addition, event information may be acquired as the recognition information because information about an event can be provided on the day of the event or the like.

Furthermore, position information, driving information, and the like regarding various vehicles under management may be acquired. Moreover, customer information may be acquired. The customer information may include the status of utilization of various vehicles (for example, vehicles such as buses and taxis), the status of utilization of various services (which may be services other than utilization of vehicles), and the like.

In step S223, information indicating whether or not any content optimized for the user is provided. The information is acquired as a reward. Supposing that an advertisement is provided as the content, information regarding an advertising effect of the advertisement is acquired.

For example, information including the usage rate and sales of a service presented in the content and the retention of the service (the percentage of people who continue to use the service) is acquired and, if the usage rate, the sales, and the retention are improved, it can be inferred that the content presented to the user is optimized. In such cases, the reward amount sharply increases. In contrast, if the usage rate, the sales, or the retention decreases, the reward amount sharply decreases.

In addition, the reward amount dependent on the viewing time of the content or on the reaction to the provided content may be acquired. For example, if the viewing time of the content is long, it can be inferred that content suitable for the user has been provided. To the contrary, if the viewing time of the content is short, it can be inferred that content suitable for the user could not be provided.

Furthermore, the reward amount dependent on the operating efficiency of a group of vehicles may be acquired. For example, if the number of users has increased due to provision of content about discounts, it can be inferred that the operating efficiency is improved. In such cases, the reward amount sharply increases.

In step S224, change information is generated by observing an increase/decrease in the reward amount. In step S225, it is determined whether or not an environment change has occurred. In step S225, if the change information is information indicating that no environment change has occurred, the processing returns to step S222, and the subsequent steps starting from S222 are repeated. On the other hand, in step S225, if the change information is information indicating that an environment change has occurred, the processing goes to step S226. In step S226, re-learning is done.

For example, in a case where a commercial facility is constructed, advertising the commercial facility increases the number of people in an area therearound, and thus it is inferred that the advertising has produced effects; however, it is inferred that the advertising will produce less effect when the boom disappears. When the advertising produces less effect, in order to increase the advertising effect again, re-learning is done so as to advertise the commercial facility preferentially as compared with other advertisements.

Quick re-learning to adapt to a new environment may be facilitated by temporarily reinforcing reward-based feedback.

### Eighth Application Example

An eighth application example of the above-described information processing device 10 is described below.

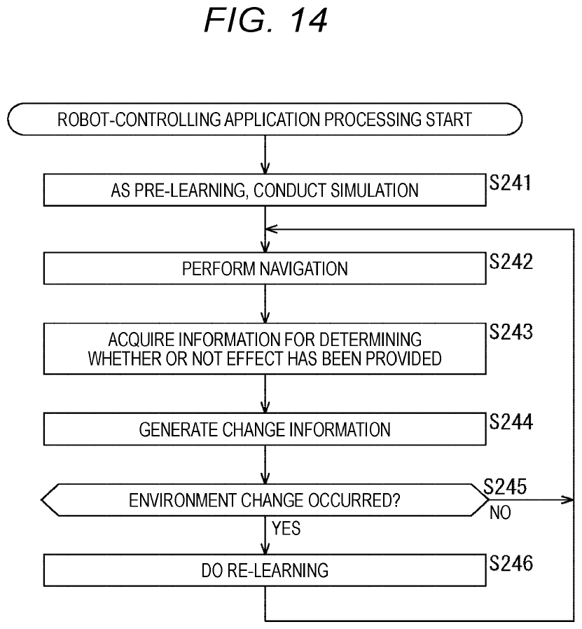

The following describes the eighth application example with reference to the flowchart shown in FIG. 14. In the eighth application example, the present technology is applied to, as an application, control of a robot. In addition, description is given about an example in which an application is applied to, for example, a guide robot in a commercial facility.

For example, the application (the information processing device 10 that operates on the basis of the application) in the eighth application example supports users (customers) in a commercial facility by answering questions from the users and directing the users to their destinations.

In the case of doing reinforcement learning involved with robot control, the action is providing some support for a user and the reward amount is the user's reaction or the like to the provided support. In addition, the re-learning is re-learning a learning model for providing support adapted to an environment change.

In step S241, pre-learning is done. The pre-learning is done by conducting a simulation in a test environment with information regarding arrangement of the tenants to be placed in the commercial facility, information regarding the tenants, and the like. In addition, after the operation is started, the learning is continued through actual interactions with users. Furthermore, for example, navigation in response to a question from a user and assurance of a feeling of distance that does not cause fear to users are learned.

In step S242, guiding (support) is provided with reference to the learning model. That is, the processing with reference to the learning model is actually performed. The recognition information (Perceptual Data) that is input when guiding is provided includes, for example, various environment conditions included in a commercial facility, information regarding the current environment, and the like. For example, information indicating that the number of tenants has decreased or increased, information indicating that tenants have been replaced, information indicating that the area of a tenant has changed, and the like are acquired. In addition, the recognition information may be information obtained from the commercial facility such as information about customers who use a tenant, or may be information obtained from users of the commercial facility.

In step S243, information for determining whether or not the guiding has created an effect is acquired. The information is acquired as a reward. For example, in a case where a user was guided, whether or not the guiding was successful, the level of customer satisfaction, and the like are acquired.

Whether or not the guiding was successful can be found by, for example, tracking and monitoring the user and determining whether or not the user has reached a desired location (tenant). In addition, the level of customer satisfaction can be found by sensing the user and determining reactions based on the sensing, for example, whether or not the user understands (understanding level) and whether or not the user is satisfied (satisfaction level). Alternatively, the stress amount or the like may be estimated through emotion and affect estimation based on facial expression recognition or biological sensing.

Furthermore, when the level of user satisfaction is increased by the guiding, such as when the user has reached a desired tenant or the user had a favorable impression of the guiding, the sales may rise. Therefore, whether or not sales have improved can be used as the reward. The reward amount increases when the sales rise, while the reward amount decreases when the sales fall.

In step S244, change information is generated by observing an increase/decrease in the reward amount. In step S245, it is determined whether or not an environment change has occurred. In step S245, if the change information is information indicating that no environment change has occurred, the processing returns to step S242, and the subsequent steps starting from S242 are repeated. On the other hand, in step S245, if the change information is information indicating that an environment change has occurred, the processing goes to step S246. In step S246, re-learning is done.

For example, when the customer is not satisfied with the conventional guiding method because of a change in tenants or change in customer groups based on the change in tenants, and it is inferred that consequently the reward amount has sharply decreased, re-learning for coping with the change in tenants or re-learning for coping with the change is customer groups is done. In addition, for example, when sales fall, re-learning is done so as to improve the sales.

### Ninth Application Example

A ninth application example of the above-described information processing device 10 is described below.

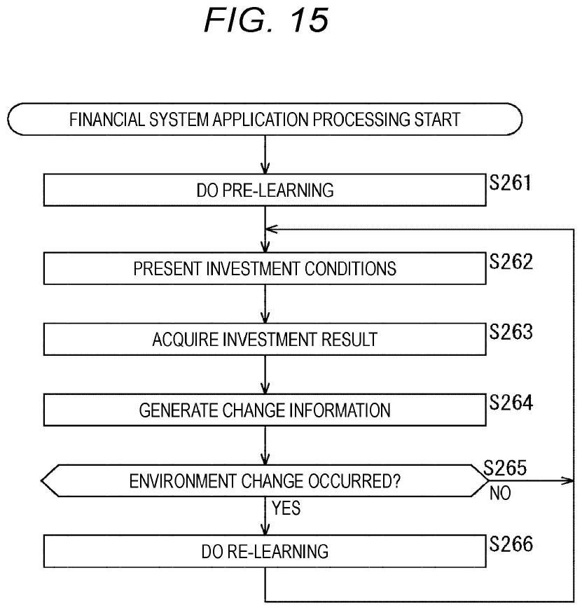

The following describes the ninth application example with reference to the flowchart shown in FIG. 15. In the ninth application example, the present technology is applied to, as an application, a financial system. In addition, description is given here about an example in which an application presents, for example, information regarding investment. For example, the application (the information processing device 10 that operates on the basis of the application) in the ninth application example monitors various economic indicators such as an exchange trend and calculates optimal investment conditions.

In step S261, pre-learning is done. The pre-learning is done by using information pertaining to instruments to be presented to the user, such as stock prices and investment trust prices.

In step S262, optimum investment conditions are provided with reference to the learning model. That is, the processing with reference to the learning model is actually performed. The recognition information (Perceptual Data) that is input when investment conditions are presented is, for example, various economic indicators such as an exchange trend, news, information regarding instruments that are topics of interest in the market, and the like.

In step S263, an investment result is acquired. The information is acquired as a reward. For example, when a profit is earned as a result of the investment based on the presented investment conditions, the reward amount increases, and when a profit is not earned (when a loss is produced), the reward amount decreases. In other words, if a return on the investment based on the presented investment conditions is obtained as forecasted at the presentation, the reward amount increases, and if the return is against the forecast, the reward amount decreases.

In step S264, change information is generated by observing an increase/decrease in the reward amount. In step S265, it is determined whether or not an environment change has occurred. In step S265, if the change information is information indicating that no environment change has occurred, the processing returns to step S262, and the subsequent steps starting from S262 are repeated. On the other hand, in step S265, if the change information is information indicating that an environment change has occurred, the processing goes to step S266. In step S266, re-learning is done.

For example, if an event that influences the economic trend, such as a policy change or an incident that influences the economy, has occurred, circumstances are now different from those in which the investment conditions were presented, and thus the investment result to be obtained may be different from the expected return. In such cases, since the result is contrary to the forecast, the reward amount sharply decreases (the result is below the forecast) or sharply increases (the result exceeds the forecast), and it is detected that an environment change has occurred, and then re-learning is done.

In such cases, re-learning is done in consideration of the event (new environment) that has occurred. If the result is lower than the forecast, re-learning is done so that the forecasted result is regained, and if the result exceeds the forecast, re-learning is done so as to produce a forecast that will further improve the result.

According to the present technology, it is possible to flexibly cope with a short-term change without being affected by an extremely short-term change such as a flash crash. That is, according to the present technology, it is possible to do stable presentation while preventing the presented investment conditions from being sharply changed by a temporary change. On the other hand, when an adverse situation that may exert influence over a long period of time occurs, re-learning can be done in consideration of the influence, and actions against the influence can be taken.

### Tenth Application Example

A tenth application example of the above-described information processing device 10 is described below.

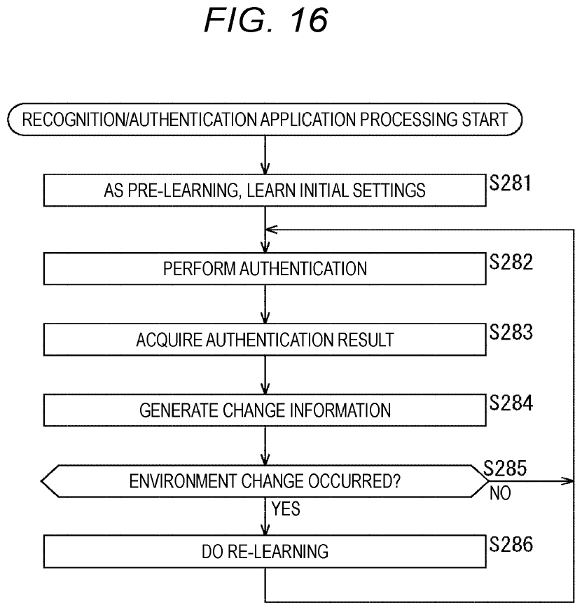

The following describes the tenth application example with reference to the flowchart shown in FIG. 16. In the tenth application example, the present technology is applied to, as an application, a system that performs recognition and/or authentication. In addition, for example, description is given here about an example in which an application performs personal authentication.

For example, the application (the information processing device 10 that operates on the basis of the application) in the tenth application example performs personal authentication using a camera in a smartphone, personal authentication using a camera in a public facility, an office, or the like, and authentication to confirm the identify of an individual on the basis of his/her usual behavioral tendencies such as, for example, behaviors on the Web and behaviors in the real world.

In the case of doing reinforcement learning involved with authentication, the action is an attempt to authenticate a user, and the reward amount is evaluation information regarding authentication accuracy based on a result of the attempt to authenticate the user. In addition, the re-learning is re-learning a learning model suitable for the state of the user.

In step S281, pre-learning is done. As the pre-learning, learning is done so as to achieve the recognition (authentication) based on feature value information such as the face and the behavioral tendencies in daily life of the user to be recognized (authenticated).

For example, in a case where the intended authentication is based on feature value information including the user's face, learning is done by taking images of the user's face from a plurality of angles to extract feature value information. In addition, in a case where the intended authentication is based on feature value information including behavioral tendencies or the like in daily like, the user's behavioral tendencies during an initial learning period are accumulated.

In step S282, authentication is performed with reference to the learning model. That is, the processing with reference to the learning model is actually performed. The recognition Information (Perceptual Data) that is input during authentication is, for example, an external feature value (in particular, multi-view or dynamic cumulative information) and behavioral information regarding the target user.

In step S283, an authentication result is acquired. The information is acquired as a reward. For example, the reward amount increases when the authentication is successful, and the reward amount decreases when the authentication is unsuccessful. That is, the evaluation information regarding authentication accuracy based on the result of an attempt to perform authentication is acquired as the reward amount.

Success authentication represents the case where the user targeted for the authentication (referred to as a true user) is authenticated as a true user. Successful authentication also includes the case where a user who is not a true user is authenticated as a non-true user. If the authentication is successful, that is, if the authentication accuracy is high, the reward amount increases.

On the other hand, unsuccessful authentication represents the case where a true user is authenticated as a non-true user, in spite of the fact that the true user is targeted for the attempt to perform authentication. Unsuccessful authentication also includes the case where a non-true user is authenticated as a true user. If the authentication is unsuccessful, that is, if the authentication accuracy is low, the reward amount decreases.

In step S283, if it is doubtful that the result of, for example, the performed face authentication is correct, in other words, if the authentication accuracy is low and the reward amount is lower than a predetermined value, another authentication method, such as authentication through password input, for example, may be carried out. After the password-based authentication, it may be determined whether or not the result of the password-based authentication is the same as the initial estimation (whether or not the initial estimation is correct).

For example, when it is not confirmed but suggested that the user may be a true user by face authentication, password input is used for the authentication. As a result, if it is confirmed that the user is a true user, it is concluded that the result of face authentication is correct, and therefore it is inferred that the accuracy of the face authentication is not decreased. On the other hand, if it is confirmed that the user is not a true user, it is concluded that the result of face authentication is incorrect, and therefore it is inferred that the accuracy of the face authentication is decreased.

As described above, re-learning is done in a situation where it can be inferred that the accuracy of authentication has decreased. That is, re-learning is done when the reward amount has sharply decreased.

In step S284, change information is generated by observing an increase/decrease in the reward amount. In step S285, it is determined whether or not an environment change has occurred. In step S285, if the change information is information indicating that no environment change has occurred, the processing returns to step S282, and the subsequent steps starting from S282 are repeated.

On the other hand, in step S285, if the change information is information indicating that an environment change has occurred, the processing goes to step S286. In step S286, re-learning is done.

For example, in the event that the user's appearance has changed, such as the cases where the user targeted for the authentication has now a different hair style, the user now wears eyeglasses, the user now wears an eye patch, the user has been injured, or the user has been sunburned, the authentication accuracy may decrease if the existing learning model is continuously used. In such cases, re-learning is done to adapt to the change in the user's appearance. In this case, the change in the user's appearance is treated as an environment change.

In addition, in the event that the user's lifestyle has changed, such as the cases where the user targeted for the authentication has switched jobs, the user has moved, or the user now has different family members, and the feature value information including behavioral tendencies in daily life that has already been learned is no longer suitable, the feature value information including behavioral tendencies in daily life suitable for the post-change lifestyle is re-learned. In this case, the change in the user's behavioral tendencies or the like is treated as an environment change.

Furthermore, for the purpose of applying another authentication method, re-learning suitable for such another authentication method may be done. For example, when it is determined that the accuracy of face authentication, which is the current authentication method, has decreased, it may be decided to shift to authentication based on behavioral tendencies, and learning for performing the authentication based on behavioral tendencies may be done as the re-learning.

As described above, in the tenth embodiment, in a case where authentication based on an authentication algorithm is unsuccessful, in other words, in a case where the accuracy of authentication based on an authentication algorithm decreases, such decrease in the accuracy can be detected by setting an appropriate reward amount. In addition, a decrease in the accuracy of an authentication algorithm can be treated as a case where some change has occurred to the user.

Here, specific application examples, namely the first to tenth application examples, have been described; however, the scope of the present technology is not limited to the above-described ten application examples. The present technology can also be applied to applications other than the above application examples.

According to the present technology, an environment change can be detected. In addition, when an environment change is detected, re-learning can be done so that the learning model currently in use is updated or a new learning model is generated.

<About Recording Media>

The aforementioned series of process steps can be executed by hardware, or can be executed by software. In a case where the series of process steps is executed by software, a program included in the software is installed in the computer. Here, examples of the computer include a computer incorporated in dedicated hardware, a general-purpose personal computer capable of executing various functions by installing various programs therein, and the like.

Regarding hardware configuration, the computer that performs the above-described series of process steps by executing programs may be configured as in the information processing device 10 illustrated in FIG. 1. The CPU 21 in the information processing device 10 illustrated in FIG. 1 loads, for example, a program stored in the storage device 30 into the RAM 23 and executes the program, thereby performing the above-described series of process steps.

The program to be executed by the computer (CPU 21) can be provided in the form of, for example, a package medium recorded in the removable recording medium 41. Furthermore, the program can be provided via a wired or wireless transmission medium such as a local area network, the Internet, or digital satellite broadcasting.

In the computer, the program can be installed in the storage device 30 via the interface 27 by loading the removable recording medium 41 into the drive 31. Furthermore, the program can also be received by the communication device 33 via a wired or wireless transmission medium to be installed in the storage device 30. Moreover, the program can be pre-installed in the ROM 22 or the storage device 30.

Note that the programs executed by the computer may be programs for process steps to be performed in time series in the order described herein, or may be programs for process steps to be performed in parallel or on an as-needed basis when, for example, a call is made.

In addition, a system herein represents the whole of an apparatus made up of a plurality of devices.

Note that the effects described herein are examples only and are not restrictive, and other effects may be provided.

Note that the embodiments of the present technology are not limited to the above-described embodiments, and various modifications can be made without departing from the scope of the present technology.

Note that the present technology may have the following configurations.

(1)

An information processing device including:

a determination unit that determines an action in response to input information on the basis of a predetermined learning model; and

a learning unit that performs a re-learning of the learning model when a change in a reward amount for the action is a change exceeding a predetermined standard.

(2)

The information processing device according to (1), in which

the learning model is a learning model generated or updated through reinforcement learning.

(3)

The information processing device according to (2), in which

the reinforcement learning is reinforcement learning that uses long short-term memory (LSTM).

(4)

The information processing device according to any one of (1) to (3), in which

it is determined whether or not a change in an environment has occurred by determining whether or not the reward amount has varied.

(5)

The information processing device according to any one of (1) to (4), in which

when the change in the reward amount for the action is a change not exceeding the predetermined standard, another re-learning different from the re-learning is performed with respect to the learning model.

(6)

The information processing device according to (5), in which

the re-learning changes the learning model to a greater extent than the another re-learning.

(7)

The information processing device according to any one of (1) to (6), in which

when the change in the reward amount for the action is a change not exceeding the predetermined standard, the re-learning of the learning model is not performed.

(8)

The information processing device according to any one of (1) to (7), in which

a new learning model obtained as a result of the re-learning is newly generated on the basis of the predetermined learning model.

(9)

The information processing device according to any one of (1) to (8), in which

when a change exceeding the predetermined standard occurs, the predetermined learning model is switched to another learning model different from the predetermined learning model, the another learning model being one of a plurality of learning models included in the information processing device or being obtainable from outside by the information processing device.

(10)

The information processing device according to any one of (1) to (9), in which

the reward amount includes information regarding a reaction of a user.

(11)

The information processing device according to any one of (1) to (10), in which

the action includes generating text and presenting the text to a user,

the reward amount includes a reaction of the user to whom the text is presented, and

the re-learning includes a re-learning of a learning model for generating the text.

(12)

The information processing device according to any one of (1) to (10), in which

the action includes making a recommendation to a user,

the reward amount includes a reaction of the user to whom the recommendation is presented, and

the re-learning includes a re-learning for making a new recommendation dependent on a change in a state of the user.

(13)

The information processing device according to any one of (1) to (12), in which

when the change in the reward amount is a change exceeding the predetermined standard, a cause of the change is inferred and a re-learning is performed on the basis of the inferred cause.

(14)

The information processing device according to any one of (1) to (13), in which

when a time period in which the reward amount does not vary extends for a predetermined time period, a re-learning for generating a new learning model is performed.

(15)

The information processing device according to any one of (1) to (10), in which

the action includes control of a moving object,

the reward amount includes environment information relating to the moving object, and

the re-learning includes a re-learning of a learning model for controlling the moving object.

(16)

The information processing device according to any one of (1) to (10), in which

the action includes an attempt to authenticate a user,

the reward amount includes evaluation information regarding authentication accuracy based on a result of the attempt to authenticate the user, and

when the change in the reward amount is a change exceeding the predetermined standard, it is determined that the user is in a predetermined specific state and a re-learning suitable for the specific state is performed.

(17)

An information processing method including:

by an information processing device,

determining an action in response to input information on the basis of a predetermined learning model; and

performing a re-learning of the learning model when a change in a reward amount for the action is a change exceeding a predetermined standard.

(18)

A program causing a computer to execute a process including steps of:

determining an action in response to input information on the basis of a predetermined learning model; and

performing a re-learning of the learning model when a change in a reward amount for the action is a change exceeding a predetermined standard.

### REFERENCE SIGNS LIST

10 Information processing device
21 CPU
22 ROM
23 RAM
24 Host bus
25 Bridge
26 External bus
27 Interface
28 Input device
29 Output device
30 Storage device
31 Drive
32 Connection port
33 Communication device
41 Removable recording medium
42 Externally connected device
43 Communication network
61 Pre-learning unit
62 Learning unit
63 Learning model storage unit
64 Recognition information acquisition unit
65 Output information generation unit
66 Reward amount setting unit
67 Change information generation unit
68 Environment change determination unit
91 Learning model

1. An information processing device comprising:
a determination unit that determines an action in response to input information on a basis of a predetermined learning model; and
a learning unit that performs a re-learning of the learning model when a change in a reward amount for the action is a change exceeding a predetermined standard.

2. The information processing device according to claim 1, wherein
the learning model is a learning model generated or updated through reinforcement learning.

3. The information processing device according to claim 2, wherein
the reinforcement learning is reinforcement learning that uses long short-term memory (LSTM).

4. The information processing device according to claim 1, wherein
it is determined whether or not a change in an environment has occurred by determining whether or not the reward amount has varied.

5. The information processing device according to claim 1, wherein
when the change in the reward amount for the action is a change not exceeding the predetermined standard, another re-learning different from the re-learning is performed with respect to the learning model.

6. The information processing device according to claim 5, wherein
the re-learning changes the learning model to a greater extent than the another re-learning.

7. The information processing device according to claim 1, wherein
when the change in the reward amount for the action is a change not exceeding the predetermined standard, the re-learning of the learning model is not performed.

8. The information processing device according to claim 1, wherein
a new learning model obtained as a result of the re-learning is newly generated on a basis of the predetermined learning model.

9. The information processing device according to claim 1, wherein
when a change exceeding the predetermined standard occurs, the predetermined learning model is switched to another learning model different from the predetermined learning model, the another learning model being one of a plurality of learning models included in the information processing device or being obtainable from outside by the information processing device.

10. The information processing device according to claim 1, wherein
the reward amount includes information regarding a reaction of a user.

11. The information processing device according to claim 1, wherein
the action includes generating text and presenting the text to a user,
the reward amount includes a reaction of the user to whom the text is presented, and
the re-learning includes a re-learning of a learning model for generating the text.

12. The information processing device according to claim 1, wherein
the action includes making a recommendation to a user,
the reward amount includes a reaction of the user to whom the recommendation is presented, and
the re-learning includes a re-learning for making a new recommendation dependent on a change in a state of the user.

13. The information processing device according to claim 1, wherein
when the change in the reward amount is a change exceeding the predetermined standard, a cause of the change is inferred and a re-learning is performed on a basis of the inferred cause.

14. The information processing device according to claim 1, wherein
when a time period in which the reward amount does not vary extends for a predetermined time period, a re-learning for generating a new learning model is performed.

15. The information processing device according to claim 1, wherein
the action includes control of a moving object,
the reward amount includes environment information relating to the moving object, and
the re-learning includes a re-learning of a learning model for controlling the moving object.

16. The information processing device according to claim 1, wherein
the action includes an attempt to authenticate a user,
the reward amount includes evaluation information regarding authentication accuracy based on a result of the attempt to authenticate the user, and
when the change in the reward amount is a change exceeding the predetermined standard, it is determined that the user is in a predetermined specific state and a re-learning suitable for the specific state is performed.

17. An information processing method comprising:
by an information processing device,
determining an action in response to input information on a basis of a predetermined learning model; and
performing a re-learning of the learning model when a change in a reward amount for the action is a change exceeding a predetermined standard.

18. A program causing a computer to execute a process comprising steps of:
determining an action in response to input information on a basis of a predetermined learning model; and
performing a re-learning of the learning model when a change in a reward amount for the action is a change exceeding a predetermined standard.
